(19) United States
(12) Patent Application Publication
(10) Pub. No.: US 2026/0003073 A1
(43) Pub. Date: Jan. 1, 2026

(54) LIGHTNING STRIKE RISK DEGREE DERIVATION DEVICE AND LIGHTNING STRIKE RISK DEGREE DISPLAY SYSTEM

(71) Applicant: MTI Ltd., Tokyo (JP)

(72) Inventors: Eiichi Yoshikawa, Chofu-shi, Tokyo (JP); Kana Koike, Tokyo (JP); Masataka Tsuchiya, Tokyo (JP)

(73) Assignee: MTI Ltd., Tokyo (JP)

(21) Appl. No.: 18/879,041

(22) PCT Filed: Jun. 30, 2023
(86) PCT No.: PCT/JP2023/024342

§ 371 Date: Dec. 26, 2024

(30) Foreign Application Priority Data
Jul. 1, 2022 (JP) 2022-106893

(51) Int. Cl. G01S 13/95; G01S 7/04; G01W 1/10

(52) U.S. Cl. CPC G01S 13/951; G01S 7/04; G01W 1/10

(57) ABSTRACT

The lightning strike risk degree derivation device comprises: an echo intensity derivation unit that derives an altitude distribution of echo intensity in a predetermined altitude range for each of the plurality of regions using observation data acquired from meteorological radar; an air temperature derivation unit that derives an altitude distribution of air temperature in the predetermined altitude range for each of the plurality of regions using observation data acquired from a meteorological observation device; a feature amount derivation unit that derives a feature amount to be used to derive a lightning strike risk degree; and a lightning strike risk degree derivation unit that derives the lightning strike risk degree using the feature amount.

### TECHNICAL FIELD

The present invention relates to a lightning strike risk degree derivation device and a lightning strike risk degree display system.

### BACKGROUND ART

A lot of lightning strikes occur throughout the year during airplane flights. While a lightning strike of an airplane itself is extremely unlikely to directly lead to a serious accident, the lightning strike damages an outer plate of an airframe, and the like, and thus, it is said that costs on the scale of several hundred million yen are required per year to repair the damage.

Further, it takes time for inspection, temporary repair, and the like, of an airplane struck by lightning, which affects a flight schedule regardless of the scale of damage. Thus, not only are costs related to repair of the damage by the lightning strike incurred, but also indirect costs increase.

The flight of an airplane is roughly divided into a takeoff and landing phase and a cruise phase, and at flight altitudes in the cruise phase, a lightning strike itself is unlikely to occur, and avoidance behavior is easily performed, and thus, lightning strikes have rarely occurred in the cruise phase.

On the other hand, at flight altitudes in the takeoff and landing phase, a lightning strike itself is likely to occur, and it is desired to avoid the lightning strike. To implement this, information using a lightning monitoring system called the Lightning Detection Network system (LIDEN) operated by the Japan Meteorological Agency is widely used.

Further, as a method for evaluating a lightning strike risk (lightning risk), there is a method in which a lightning strike risk is evaluated using observation data by meteorological radar and lightning data (Patent Document 1).

### CITATION LIST

### Patent Document

Patent Document 1: Japanese Patent Laid-Open No. 2022-651

### SUMMARY OF THE INVENTION

### Problem To Be Solved By The Invention

However, while such related art enables evaluation of a planar (two-dimensional) lightning strike risk and avoidance behavior in a horizontal direction, utilization of the related art is difficult in a takeoff and landing phase in which it is difficult to perform avoidance behavior itself. Thus, a method of deriving a three-dimensional lightning strike risk that enables avoidance behavior both in a horizontal direction and in a vertical direction is desired.

The present invention has been made in view of the above-described problem and provides a lightning strike risk degree derivation device capable of deriving a three-dimensional lightning strike risk, and a lightning strike risk degree display system.

### Means For Solving The Problem

The present invention is a lightning strike risk degree derivation device that derives a lightning strike risk degree for each of a plurality of regions divided by latitude and longitude into a mesh shape, and includes an echo intensity derivation unit that derives an altitude distribution of echo intensity for each of the plurality of regions using observation data acquired from meteorological radar, an air temperature derivation unit that derives an altitude distribution of air temperature for each of the plurality of regions using observation data acquired from a meteorological observation device, a feature amount derivation unit that derives a feature amount to be used to derive a lightning strike risk degree, and a lightning strike risk degree derivation unit that derives the lightning strike risk degree using the feature amount, and the feature amount derivation unit derives integrated echo intensity that is an integrated value of the echo intensity in part of the whole in a vertical direction for each of the plurality of regions, and the lightning strike risk degree derivation unit derives an altitude distribution of the lightning strike risk degree for each of the plurality of regions using the integrated echo intensity and the altitude distribution of the air temperature.

### Effect Of The Invention

According to the present invention, it is possible to provide a lightning strike risk degree derivation device capable of deriving a three-dimensional lightning strike risk, and a lightning strike risk degree display system.

### BRIEF DESCRIPTION OF THE DRAWINGS

FIG. 1 is a functional block diagram illustrating a configuration of a lightning strike risk degree derivation device according to the present embodiment.

FIG. 2 is a flowchart indicating processing of deriving a distribution of echo intensity.

FIG. 3 is a flowchart indicating processing of deriving respective feature amounts.

FIG. 4 is a flowchart indicating processing of deriving a distribution of air temperature.

FIG. 5A is a view indicating an altitude difference between adjacent isobaric surfaces derived by a hypsometric formula, and data necessary for deriving the altitude difference.

FIG. 5B is a view indicating the hypsometric formula.

FIG. 6 is a flowchart indicating processing of deriving a lightning strike risk degree that is two-dimensional information using the respective feature amounts.

FIG. 7 is a flowchart indicating processing of deriving an altitude distribution of the lightning strike risk degree using the lightning strike risk degree that is two-dimensional information, and the distribution of the air temperature.

### DESCRIPTION OF EMBODIMENTS

An embodiment of the present invention will be described below using the drawings. Note that in all the drawings, similar components are denoted by the same reference numerals, and description thereof will not be repeated.

### Outline of Lightning Strike Risk Degree Derivation Device according to the Present Embodiment

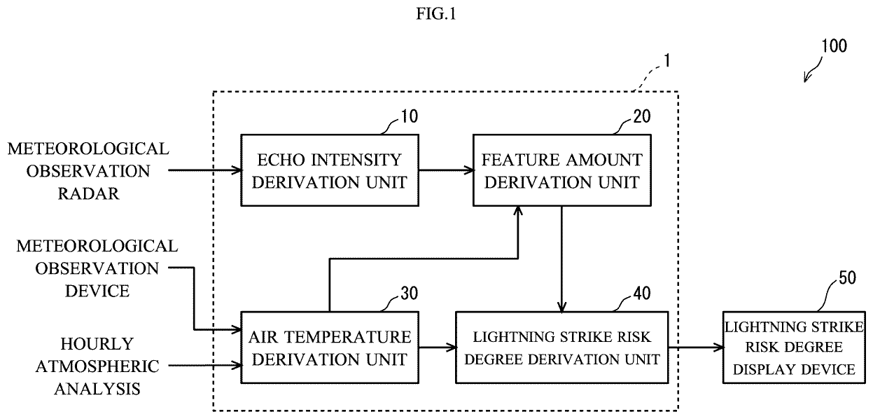

First, an outline of a lightning strike risk degree derivation device according to the present embodiment will be described using FIG. 1.

FIG. 1 is a functional block diagram illustrating a configuration of the lightning strike risk degree derivation device according to the present embodiment.

As illustrated in FIG. 1, a lightning strike risk degree derivation device 1 according to the present embodiment includes an echo intensity derivation unit 10, a feature amount derivation unit 20, an air temperature derivation unit 30, and a lightning strike risk degree derivation unit 40.

The echo intensity derivation unit 10 derives an altitude distribution of echo intensity (in the present embodiment, as one example, divided into 100 m intervals) for each of a plurality of regions divided by latitude and longitude (in the present embodiment, both latitude and longitude are divided into 0.005 degree intervals) into a mesh shape, from observation data acquired from a plurality of meteorological radars.

In the present embodiment, as the meteorological radar, a C-band radar which is controlled by the Japan Meteorological Agency and which radiates a single radio wave in a C band to the atmosphere and observes intensity of the reflected wave (hereinafter, echo intensity) is employed.

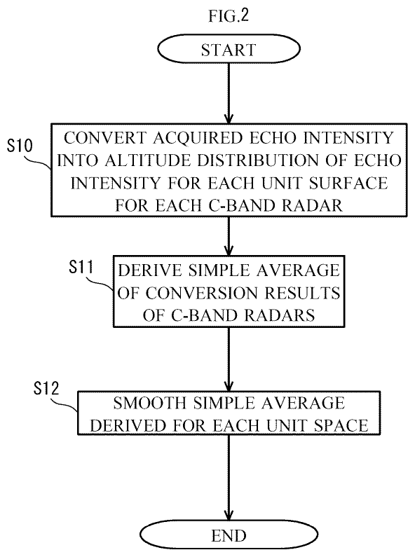

Further, the echo intensity that is observation data to be acquired from each meteorological radar is a distribution of the echo intensity in a spherical coordinate system centering on each meteorological radar, and the distribution is acquired as echo intensity for each space designated by an elevation angle, an azimuth angle, and a direct distance. Thus, to derive the altitude distribution of the echo intensity for each of the plurality of regions, it is necessary to process the echo intensity acquired from each meteorological radar, and details of processing related to the echo intensity derivation unit 10 including the processing will be described later using FIG. 2.

Note that in the following description, the altitude distribution of the echo intensity for each of the plurality of regions will be simply expressed as “distribution of echo intensity”. Further, each of the regions constituting the plurality of regions will be referred to as a “unit surface”, and each space divided into 100 m intervals on each unit surface will be referred to as a “unit space”. Further, unless otherwise described, the echo intensity refers to echo intensity corresponding to one unit space.

Further, while an area of the plurality of regions is not particularly limited in the present invention, it is assumed in the present embodiment that the plurality of regions has an area in a horizontal direction having nearly an equal size that covers the whole territory of Japan including the Japanese coastal waters. Still further, while a top altitude of the unit space located at the highest altitude among the unit spaces provided on the respective unit surfaces is not particularly limited, it is assumed in the present embodiment that the top altitude is set at 15,000 m in consideration of a detectable range by the meteorological radar. The top altitude corresponds to an upper limit of a “predetermined altitude range” in the present invention, and a surface altitude (height above sea level) is set as a lower limit of the “predetermined altitude range”. Further, in the description of the present embodiment, unless otherwise described, the “altitude distribution” indicates altitude distribution in the “predetermined altitude range”. Further, the term “altitude” in the present invention indicates an altitude based on an average sea level of Tokyo Bay.

The echo intensity (one example of so-called precipitation intensity) is an index that evaluates an amount of raindrops included in the space corresponding to the echo intensity, and a unit of the echo intensity is dBZ. Further, there is typically a positive correlation relationship between the echo intensity and a lightning strike risk degree.

Further, as some or all of the plurality of meteorological radars, a C-band multiparameter radar (C-band MP radar) that radiates two types of radio waves (a horizontal polarized wave and a vertical polarized wave) in a C band and observes echo intensity of the radio waves, an X-band radar that radiates a single radio wave in an X band, an X-band multiparameter radar (X-band MP radar) that radiates a horizontal polarized wave and a vertical polarized wave in the X band, or a combination thereof may be employed.

The feature amount derivation unit 20 derives a feature amount to be used to derive the lightning strike risk degree using distribution of the echo intensity derived by the echo intensity derivation unit 10, and distribution of air temperature derived by the air temperature derivation unit 30 (which will be described in detail later) for each unit surface.

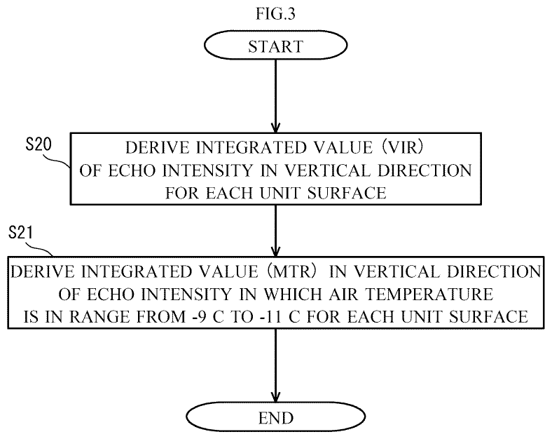

In the present embodiment, the feature amount includes an integrated value of the echo intensity in a vertical direction (in the whole predetermined altitude range) (hereinafter, referred to as “VIR”) and an integrated value in the vertical direction of the echo intensity related to a unit space in which air temperature falls within a specific temperature zone within the predetermined altitude range (hereinafter, referred to as “MTR”), and these feature amounts are both integrated values in the vertical direction, and thus are two-dimensional information (hereinafter, simply expressed as “two-dimensional information”) not including altitude information. Note that details of processing of deriving these feature amounts will be described later using FIG. 3.

Here, the specific temperature zone is a temperature range in which it is considered that charge of clouds is likely to occur from past lightning strike cases of airplanes, and in the present embodiment, the specific temperature zone is set as a range from −9° C. to −11° C.

Further, the lightning strike risk degree derivation unit 40 may derive the lightning strike risk degree using the VIR without using the MTR between these feature amounts, in which case, it is not necessary to derive the MTR. In a similar manner, the lightning strike risk degree derivation unit 40 may derive the lightning strike risk degree using the MTR without using the VIR between these feature amounts, in which case, it is not necessary to derive the VIR. In other words, the lightning strike risk degree derivation unit 40 may only derive the lightning strike risk degree using at least one of the VIR or the MTR.

The air temperature derivation unit 30 derives an altitude distribution of air temperature for each unit surface from the observation data acquired from a plurality of meteorological observation devices, and an analysis result of hourly atmospheric analysis provided by the Japan Meteorological Agency. A division interval of the altitude distribution of the air temperature can be made the same as a division interval of the echo intensity. This makes it possible to reduce a calculation amount while preventing degradation of estimation accuracy of the lightning strike risk degree. Specifically, in the present embodiment, division into 100 m intervals is used in a similar manner to the echo intensity.

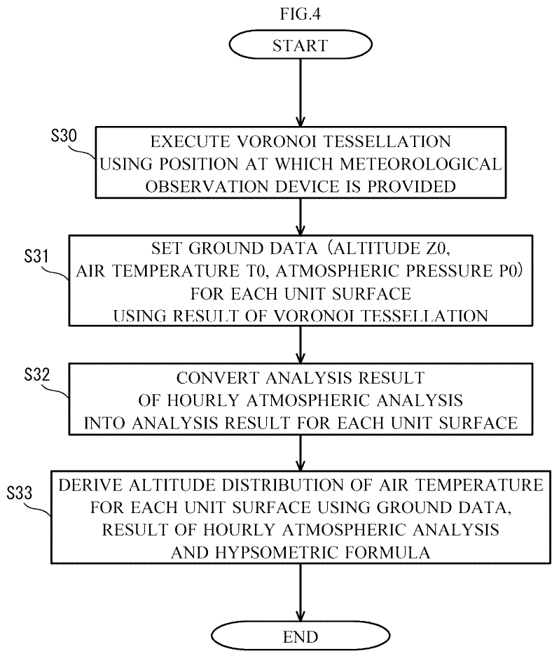

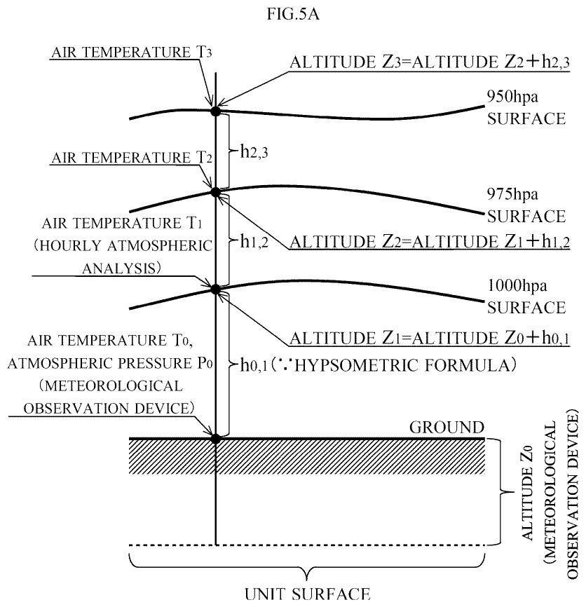

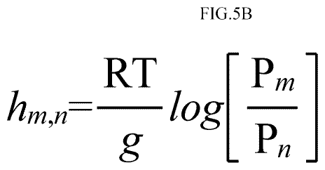

In the present embodiment, as the plurality of meteorological observation devices, meteorological observation devices for ground weather observation by the meteorological offices are employed, and observation data acquired from each meteorological observation device includes air temperature and atmospheric pressure. Further, an altitude at which each meteorological observation device is provided is also referred to when the altitude distribution of the air temperature described above is derived. Still further, air temperatures respectively corresponding to a plurality of isobaric surfaces (in the present embodiment, a 1000 hPa surface, a 975 hPa surface, a 950 hPa surface, and the like, and the number thereof is not particularly limited if 15,000 m that is the top altitude described above related to the unit space is covered) are derived for each unit surface from the analysis result of the hourly atmospheric analysis. Details of processing of deriving the altitude distribution of the air temperature will be described later using FIG. 4 and FIG. 5.

Note that as some or all of the plurality of meteorological observation devices, meteorological observation devices different from the meteorological observation devices described above may be employed if air temperature, atmospheric pressure and altitude can be acquired. In a similar manner, if the air temperatures respectively corresponding to a plurality of isobaric surfaces can be derived for each unit surface, the hourly atmospheric analysis may be replaced with other atmospheric analysis such as 30-minute atmospheric analysis.

Further, in the description according to the present embodiment, the altitude distribution of the air temperature for each unit surface will be simply expressed as “air temperature distribution”.

The lightning strike risk degree derivation unit 40 derives an altitude distribution of the lightning strike risk degree for each unit surface using the feature amounts (VIR, MTR) that are two-dimensional information derived by the feature amount derivation unit 20, and the air temperature distribution derived by the air temperature derivation unit 30.

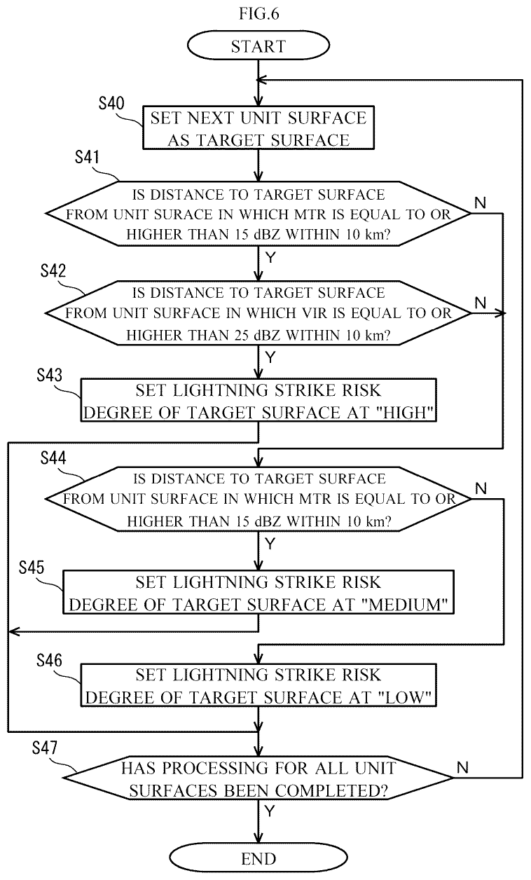

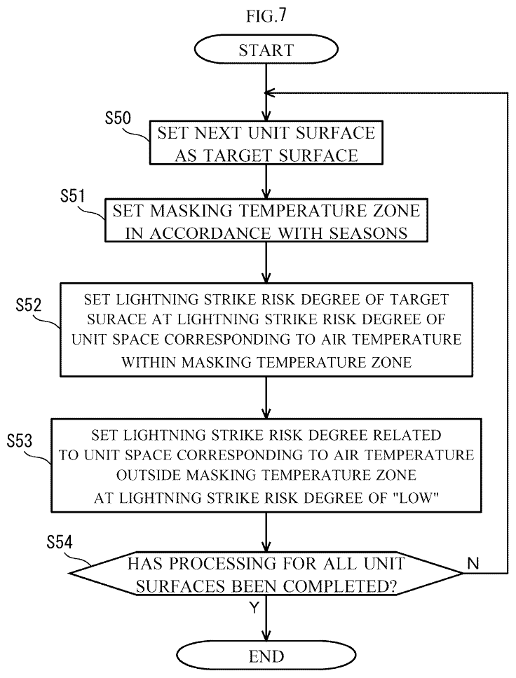

In evaluation of the lightning strike risk degree in the present embodiment, three stages of “high”, “medium” and “low” are provided in descending order of the lightning strike risk degree, and details of the derivation processing will be described later using FIG. 6 and FIG. 7. However, the number of stages related to evaluation of the lightning strike risk degree is not limited to three, and an arbitrary number of stages equal to or larger than two can be employed.

Further, as will be described later, while in the present embodiment, a method is employed in which the altitude distribution of the lightning strike risk degree is derived by masking the lightning strike risk degree that is two-dimensional information using a masking temperature zone, the method is not limited to this. In other words, any method may be employed if the method is a method in which the lightning strike risk degree is converted into three-dimensional information (altitude distribution of the lightning strike risk degree) by reevaluating the lightning strike risk degree that is two-dimensional information using the air temperature distribution.

Further, as will be described later, while in the present embodiment, the altitude distribution of the lightning strike risk degree is derived using the air temperature distribution after the lightning strike risk degree is derived once using the feature amounts that are two-dimensional information, the method is not limited to this. For example, the altitude distribution of the lightning strike risk degree may be directly derived using the feature amounts that are two-dimensional information and the air temperature distribution in combination without deriving the lightning strike risk degree that is two-dimensional information.

In this manner, the lightning strike risk degree derivation device 1 having the functional configuration described above implements derivation of the altitude distribution of the lightning strike risk degree (three-dimensional lightning strike risk) not implemented in the related art, and utilization of the altitude distribution of the lightning strike risk degree contributes to prevention of a lightning strike of an airplane.

Further, as illustrated in FIG. 1, in the present invention, a lightning strike risk degree display system 100 including the lightning strike risk degree derivation device 1 described above, and a lightning strike risk degree display device 50 that displays the altitude distribution of the lightning strike risk degree derived by the lightning strike risk degree derivation unit 40 in a three-dimensional manner, may be configured.

As the lightning strike risk degree display device 50, any device such as a tablet terminal and a stationary terminal may be employed if the altitude distribution of the lightning strike risk degree can be displayed in a three-dimensional manner.

According to this, it is possible to encourage a pilot of an airplane or a ground controller to visually recognize the altitude distribution of the lightning strike risk degree and determine a course (particularly, a route upon takeoff and landing) in consideration of the altitude distribution of the lightning strike risk degree.

Further, other examples in which the altitude distribution of the lightning strike risk degree is utilized are not limited to the lightning strike risk degree display system 100 described above and may include a system, or the like, that automatically determines a course of a flight vehicle such as an airplane or candidates for the course with reference to the altitude distribution of the lightning strike risk degree.

### Processing of Deriving Distribution of Echo Intensity

Details of processing of deriving an altitude distribution of echo intensity (echo intensity distribution) for each unit surface from the echo intensity acquired from each meteorological radar will be described next using FIG. 2.

FIG. 2 is a flowchart indicating the processing of deriving the distribution of echo intensity, and the processing is executed by the echo intensity derivation unit 10.

As indicated in FIG. 2, in step S10 that is the first step, echo intensity acquired in a detection range of each C-band radar is converted into an altitude distribution of echo intensity for each unit surface.

Specifically, the distribution of the echo intensity in a spherical coordinate system centering on the C-band radar described above is once converted into distribution of the echo intensity in a rectangular coordinate system centering on the earth using latitude and longitude at which the C-band radar is provided, and the conversion result is converted into the altitude distribution of the echo intensity (echo intensity distribution) for each unit surface.

In step S11, a simple average of the conversion results of the respective C-band radars derived in step S10 is derived.

Specifically, a simple average of the conversion results of the respective C-band radars is derived for each unit space.

In step S12, the simple average related to the echo intensity for each unit space derived in step S11 is smoothed.

Specifically, a simple average of echo intensity corresponding to 500 unit spaces defined by 10 unit spaces in a latitude direction, 10 unit spaces in a longitude direction, and 5 unit spaces in an altitude direction, including a target unit space is set as echo intensity in the target unit space.

This can smooth change of the echo intensity related to the unit space. Further, this contributes to smoothing of change of each feature amount related to the unit space.

Note that to obtain the effect, a range of the unit space (including the target unit space) to be used for smoothing the simple average related to the echo intensity is not particularly limited and is only required to include a plurality of unit spaces respectively in the latitude direction, in the longitude direction and in the altitude direction.

### Processing of Deriving Respective Feature Amounts

Details of processing of deriving the respective feature amounts (VIR, MTR) from the distribution of the echo intensity and the distribution of the air temperature will be described next using FIG. 3.

FIG. 3 is a flowchart indicating the processing of deriving the respective feature amounts, and the processing is executed by the feature amount derivation unit 20.

As indicated in FIG. 3, in step S20 that is the first step, the integrated value (VIR) of the echo intensity in the vertical direction (the whole predetermined altitude range) is derived for each unit surface.

In step S21, the integrated value in the vertical direction of the echo intensity related to the unit spaces in which air temperatures fall within a specific temperature zone (first temperature range) within the predetermined altitude range is derived for each unit surface. The first temperature range is specifically from −9° C. to −11° C. Note that in step S21, while there are cases where the unit spaces in which the air temperatures fall within the specific temperature zone are discontinuous in the vertical direction, in such cases, all values of the echo intensity corresponding to the discontinuous unit spaces are integrated.

### Processing of Deriving Distribution of Air Temperature

Details of processing of deriving an altitude distribution (air temperature distribution) of air temperature for each unit surface from the observation data acquired from each meteorological observation device and the analysis result of the hourly atmospheric analysis will be described next using FIG. 4 and FIG. 5.

FIG. 4 is a flowchart indicating the processing of deriving the air temperature distribution, and the processing is executed by the air temperature derivation unit 30. FIG. 5A is a view indicating an altitude difference between adjacent isobaric surfaces derived by a hypsometric formula, and data necessary for deriving the altitude difference, and FIG. 5B is a view indicating the hypsometric formula.

As indicated in FIG. 4, in step S30 that is the first step, Voronoi tessellation is executed using points at which a plurality of meteorological observation devices is provided.

Specifically, by drawing a perpendicular bisector on a line connecting adjacent sites (points at which the meteorological observation devices are provided) while ignoring altitude differences of the points at which the plurality of meteorological observation points is provided, a region closest to each site (hereinafter, referred to as a “divided region”) is derived.

In step S31, ground data (altitude Z₀, air temperature T₀, atmospheric pressure P₀) corresponding to the unit surface is set using a result of the Voronoi tessellation in step S30.

Specifically, ground data of the meteorological observation device corresponding to the divided region including the center of the unit surface is set as the ground data of the unit surface for each unit surface.

In step S32, an analysis result of the hourly atmospheric analysis (air temperatures respectively corresponding to the plurality of isobaric surfaces) is converted into data for each unit surface.

Specifically, an analysis result of a unit region (region divided by latitude of 0.0625 degrees and longitude of 0.05 degrees) related to the hourly atmospheric analysis including the center of the unit surface is set as data of the unit surface for each unit surface.

In step S33, the altitude distribution of the air temperature for each unit surface is derived using the ground data, the conversion result of the hourly atmospheric analysis (air temperatures respectively corresponding to the plurality of isobaric surfaces corresponding to the respective unit surfaces) and the hypsometric formula.

Specifically, an average air temperature T(K) of two adjacent isobaric surfaces and atmospheric pressures of the two isobaric surfaces (which are Pₘ, Pₙ, and the unit of both is hPa) are input to the hypsometric formula indicated in FIG. 5B to derive thicknesses h_{m,n} (m) of the two isobaric surfaces. Then, by sequentially adding the thicknesses h_{m,n} to the altitude Z₀ of the ground data, a correspondence relationship between an altitude Zₙand an air temperature Tₙ can be derived for a unit surface that is currently a target. Note that in the hypsometric formula, R is a gas constant of dry air, and g is gravity acceleration (m/s²).

For example, to derive a thickness h_{1,2} of the isobaric surface, average air temperature T=(air temperature T₁+air temperature T₂)/2, atmospheric pressure Pₘ=atmospheric pressure P₁ (1000 hPa), and atmospheric pressure Pₙ=atmospheric pressure P₂ (975 hPa) are input to the hypsometric formula.

Particularly, to derive a thickness h_{0,1} from the ground to the closest isobaric surface, average air temperature T=(air temperature T₀+air temperature T₁)/2, atmospheric pressure Pₘ=atmospheric pressure P₀, atmospheric pressure Pₙ=atmospheric pressure P₁ (1000 hPa) are input to the hypsometric formula using the ground data (air temperature T₀, atmospheric pressure P₀). Then, an altitude Z₁ is derived for a unit surface that is currently a target by adding the derived thickness h_{0,1} to the altitude Z₀. Further, altitudes of the respective isobaric surfaces are derived by adding thicknesses of the isobaric surfaces that are sequentially derived, in such a manner that an altitude Z₂ is derived by adding a thickness h_{1,2} to the altitude Z₁.

Note that as described above, the altitude distribution of the air temperature in the present embodiment is an air temperature of the unit space divided into 100 m intervals for each unit surface. Thus, in the present embodiment, the air temperature of the unit space is derived through linear interpolation using the altitude and the air temperature related to each isobaric surface derived using the hypsometric formula.

In this manner, in the present embodiment, to derive the altitude distribution of the air temperature using the hypsometric formula on each unit surface, ground data corresponding to each unit surface is determined by Voronoi tessellation using the points at which the plurality of meteorological observation devices (for ground weather observation by the meteorological offices) is provided.

This associates ground data of the closest meteorological observation device with each unit surface, so that it is possible to improve accuracy of the altitude distribution of air temperature on each unit surface. Further, the improvement of the accuracy contributes to improvement of accuracy of the altitude distribution of the lightning strike risk degree.

Note that while in the present embodiment, the air temperature derivation unit 30 executes processing of determining the ground data corresponding to the respective unit surfaces by Voronoi tessellation using the points at which the plurality of meteorological observation devices is provided, the meteorological observation devices corresponding the respective unit surfaces may be determined in advance by Voronoi tessellation using the points at which the plurality of meteorological observation devices is provided. In other words, the air temperature derivation unit 30 does not have to execute processing of determining the ground data corresponding to the respective unit surfaces by Voronoi tessellation using the points at which the plurality of meteorological observation devices is provided.

Further, in a case where the plurality of meteorological observation devices has an abnormality (such as a case where there is an abnormality in the acquired ground data and a case where the ground data itself cannot be acquired), the air temperature derivation unit 30 may execute processing of determining the ground data corresponding to the respective unit surfaces by Voronoi tessellation using the points at which the plurality of meteorological observation devices except the meteorological observation device having the abnormality is provided.

However, in such a case where the meteorological observation device has an abnormality, after the ground data corresponding to the respective unit surfaces is determined by Voronoi tessellation using the points at which the plurality of meteorological observation devices is provided including the meteorological observation device having the abnormality as usual, the ground data of the unit surface corresponding to the meteorological observation device having the abnormality may be replaced with past ground data of the unit surface (particularly, latest normal ground data).

### Processing of Deriving Altitude Distribution of Lightning Strike Risk Degree

Details of processing of deriving the altitude distribution of the lightning strike risk degree using the respective feature amounts (VIR, MTR) and the air temperature distribution will be described next using FIG. 6 and FIG. 7.

FIG. 6 is a flowchart indicating the processing of deriving the lightning strike risk degree that is two-dimensional information using the respective feature amounts, FIG. 7 is a flowchart indicating the processing of deriving the altitude distribution of the lightning strike risk degree using the lightning strike risk degree that is two-dimensional information and the air temperature distribution, and these kinds of processing are both executed by the lightning strike risk degree derivation unit 40.

As indicated in FIG. 6, in step S40 that is the first step, the next unit surface is set as a target surface.

Here, the target surface refers to a unit surface to be referred to in the subsequent processing. Further, the next unit surface refers to the next unit surface in the order for setting all the unit surfaces constituting the above-described plurality of regions as the target surface, and when step S40 is executed for the first time, the first unit surface in the order is set as the target surface. These similarly apply to FIG. 7.

In step S41, it is determined whether or not a distance to the target surface from a unit surface in which the MTR is equal to or higher than 15 dBZ is within 10 km, and in a case where the condition is satisfied, the processing proceeds to step S42, and in a case where the condition is not satisfied, the processing proceeds to step S44.

In step S42, it is determined whether or not a distance to the target surface from a unit surface in which the VIR is equal to or higher than 25 dBZ is within 10 km, and in a case where the condition is satisfied, the processing proceeds to step S43, and in a case where the condition is not satisfied, the processing proceeds to step S44.

In step S43, a lightning strike risk degree (two-dimensional information) of the target surface is set at “high”.

Note that each of the above-described “distance from the unit surface” is a distance from the center of the unit surface, and the distance is derived with reference to latitude and longitude of the center of the unit surface, and latitude and longitude of the center of the corresponding target surface.

In step S44, it is determined whether or not a distance to the target surface from a unit surface in which the MTR is equal to or higher than 15 dBZ is within 10 km, and in a case where the condition is satisfied, the processing proceeds to step S45, and in a case where the condition is not satisfied, the processing proceeds to step S46.

In step S45, the lightning strike risk degree of the target surface is set at “medium”.

In step S46, the lightning strike risk degree of the target surface is set at “low”.

In step S47, it is determined whether or not processing for all the unit surfaces has been completed, and in a case where the condition is satisfied, the processing indicated in FIG. 6 is finished, and in a case where the condition is not satisfied, the processing returns to step S40.

Note that while the same determination processing (step S41, step S44) is provided in the above-described processing (from step S41 to step S45), the determination processing may be executed once. This can be implemented by, in a case where the condition related to the same determination processing is satisfied, setting the lightning strike risk degree of the target surface at “medium” and then executing the determination processing in step S42 for the target surface for which the lightning strike risk degree is “medium” and updating the lightning strike risk degree of the target surface for which the condition related to the determination processing is satisfied at “high”. Further, as a method for executing the same determination processing once in the above-described processing (from step S41 to step S45), a method may be employed in which the processing in step S45 is executed in a case where the condition related to step S42 is not satisfied, and the processing in step S46 is executed in a case where the condition related to step S41 is not satisfied in the processing indicated in FIG. 6.

Subsequently, as indicated in FIG. 7, in step S50 that is the first step, the next unit surface is set as the target surface.

In step S51, a masking temperature zone according to seasons is set. The lightning strike risk degree derivation unit 40 stores a plurality of seasons and information indicating masking temperature zones associated with the respective seasons in a storage unit (not shown in the drawings). While temperature ranges of the masking temperature zones for the respective seasons are different from each other, overlapping of part of the temperature ranges is allowed.

Specifically, in a case of winter (from October to March), the masking temperature zone is set at −10° C. to 0° C., in a case of summer (from April to September), the masking temperature zone is set at −10° C. to +5° C., and these masking temperature zones are derived from past lightning strike cases. If the lightning strike risk degree derivation unit 40 accepts an input that designates the date or the season, the lightning strike risk degree derivation unit 40 acquires and sets information indicating the corresponding masking temperature zone with reference to the storage unit.

In step S52, the lightning strike risk degree (two-dimensional information) of the target surface is set as the lightning strike risk degree of the unit space corresponding to the air temperature within the masking temperature zone set in step S51.

In step S53, the lightning strike risk degree related to the unit space corresponding to air temperature outside the masking temperature zone set in step S51 is set at the lightning strike risk degree of “low”. By this means, the lightning strike risk degree of the corresponding unit space is masked by the masking temperature zone (second temperature range).

In step S54, it is determined whether processing for all the unit surfaces has been completed, and in a case where the condition is satisfied, the processing indicated in FIG. 7 is finished, and in a case where the condition is not satisfied, the processing returns to step S50.

Note that while in the present embodiment, as described above, the lightning strike risk degree of the unit space is set by determining whether the air temperature is within the masking temperature zone or the air temperature is outside the masking temperature zone with reference to the air temperature of the unit space for each unit space for one single unit surface, the present invention is not limited to this. For example, a unit space corresponding to a lower limit of the masking temperature zone (in a case where there are a plurality of lower limits, a unit space with the lowest altitude, hereinafter, referred to as a “lower limit unit space”) and a unit space corresponding to an upper limit of the masking temperature zone (in a case where there are a plurality of upper limits, a unit space with the highest altitude, hereinafter referred to as an “upper limit unit space”) may be derived, and the lightning strike risk degree of the target surface may be set at these unit spaces and all the unit spaces between these unit spaces. This is attributed to a fact that air temperature of the unit space between the lower limit unit space and the upper limit unit space corresponds to an air temperature range (masking temperature zone) determined by the air temperature of the lower limit unit space and the air temperature of the upper limit unit space in consideration of an air temperature lapse rate.

In this manner, in the present embodiment, after the lightning strike risk degree that is two-dimensional information is derived once using the feature amounts (VIR, MTR) that are two-dimensional information, an altitude distribution of the lightning strike risk degree (using the lightning strike risk degree as three-dimensional information) is derived using the air temperature distribution. Particularly, thresholds (thresholds related to step S41, step S42 and step S44) when the lightning strike risk degree that is two-dimensional information is derived are thresholds derived using past lightning strike cases of airplanes (combinations of past courses of airplanes struck by lightning and meteorological conditions at those times).

According to this, when the altitude distribution of the lightning strike risk degree is derived, it is possible to reduce the number of samples of past lightning strike cases of airplanes necessary for determining the thresholds related to derivation of the lightning strike risk degree that is two-dimensional information and improve accuracy itself of the thresholds.

Note that the above-described thresholds may be changed as appropriate by lightning strike cases of airplanes to be collected hereafter or may be changed as appropriate in consideration of meteorological parameters other than the echo intensity.

Note that as described above, to derive the lightning strike risk degree that is two-dimensional information, it is also possible to employ one of the VIR and the MTR without employing the other.

Specifically, in a case where the VIR is used to derive the lightning strike risk degree that is two-dimensional information without using the MTR, it is only necessary to delete step S41, step S44 and step S45 in the processing indicated in FIG. 6 and execute step S42 subsequent to step S40, and in a case where the determination condition related to step S42 is not satisfied, it is only necessary to execute step S46. Note that in the modification, in a case where the determination condition related to step S42 is satisfied, step S43 is executed.

On the other hand, in a case where the MTR is used to derive the lightning strike risk degree that is two-dimensional information without using the VIR, it is only necessary to delete step S42, step S44 and step S45 in the processing indicated in FIG. 6, in a case where the determination condition related to step S41 is satisfied, it is only necessary to execute step S43, and in a case where the determination condition related to step S41 is not satisfied, it is only necessary to execute step S46.

In these modifications, while the lightning strike risk degree that is two-dimensional information has two stages of “high” and “low”, by adding another threshold to a current one stage of a threshold for the threshold related to the feature amount to be used (one of the VIR and the MTR), the stage of the two-dimensional lightning strike risk degree may be made three stages of “high”, “medium” and “low” in a similar manner to the present embodiment.

Further, as described above, in the present embodiment, to derive the altitude distribution of the lightning strike risk degree, the masking temperature zone to be referred to is set at the temperature zone in accordance with the seasons.

This can improve accuracy of the altitude distribution of the lightning strike risk degree.

Note that in the present embodiment, the masking temperature zone may be switched with reference to a meteorological situation such as air temperature and tendency of a pressure pattern. Further, the masking temperature zone may be switched among four seasons as well as being switched between two seasons of winter and summer.

Further, the masking temperature zone may be determined in accordance with latitude, weather and geography of a region for which the altitude distribution of the lightning strike risk degree is to be derived.

Further, as described above, while the masking temperature zone can change according to the above-described parameters (for example, the seasons), the masking temperature zone is allowed to partially overlap with the above-described specific temperature zone (from −9° C. to −11° C.) in any temperature zone. Particularly, the lower limit of the masking temperature zone (which is constant regardless of the season and is −10° C.) is included in the specific temperature zone.

This can improve influence on the temperature zone around −10° C. in which cloud is likely to charge when the altitude distribution of the lightning strike risk degree is derived using the MTR in addition to the VIR.

While the lightning strike risk degree derivation device according to the present embodiment has been described above with reference to the drawings, these are examples of the present invention, and various configurations other than the above can be employed. Particularly, the input data to the echo intensity derivation unit 10 and the air temperature derivation unit 30 described above may be prediction data.

Further, the above-described embodiments can be combined as appropriate without departing from the gist of the present invention.

### Modifications Related to Processing of Deriving Altitude Distribution of Lightning Strike Risk Degree

The following modifications may be employed as the processing of deriving the altitude distribution of the lightning strike risk degree described above.

First, in a first modification, immediately before step S47 in the processing indicated in FIG. 6, processing of determining whether an altitude (altitude in the center in the vertical direction in the unit space) related to the unit space on the target surface in which the temperature is included in the above-described specific temperature zone (−9° C. to −11° C.) is lower than 1000 m, in a case where the condition is satisfied, overwriting the lightning strike risk degree of the target surface to “low”, and in a case where the condition is not satisfied, maintaining the lightning strike risk degree of the target surface set so far (set from step S41 to step S46) is added. This is attributed to a statistic of natural lightning that few lightning strikes occur in cases where the specific temperature zone is located at an altitude lower than 1000 m.

This can improve accuracy related to the altitude distribution of the lightning strike risk degree.

Note that an execution position and processing content of the processing added in the description according to the first modification is not limited to the above-described content if, for each unit surface in which the altitude related to the unit space in which the temperature is included in the specific temperature zone is lower than 1000 m, the lightning strike risk degrees related to all the unit spaces (unit spaces above the unit surface) corresponding to the unit surface are set at “low”. Further, the threshold (altitude of 1000 m) according to the first modification may be changed as appropriate by the lightning strike cases of airplanes to be collected hereafter.

Further, to employ the first modification, any type of the feature amount can be referred to derive the lightning strike risk degree that is two-dimensional information. In other words, the first modification can be employed in all cases of a case where both the VIR and the MTR are employed as the feature amounts, a case where only the VIR is employed, and a case where only the MTR is employed. This similarly applies to a second modification to be described later.

Subsequently, in the second modification, immediately before step S54 in the processing indicated in FIG. 7, processing of setting the lightning strike risk degree related to the unit space located at a position lower than a cloud base at “low” is added. This is also attributed to a fact that a less lightning strike occurs at an altitude lower than the cloud base in the past lightning strike cases of airplanes. Note that the cloud base indicates the lowest altitude in a range in the vertical direction where clouds exist, and in the present modification, is derived using information (such as cloud amount, altitude, relative humidity and air temperature) acquired from a numerical prediction model such as a meso-scale model (MSM) and a local forecast model (LFM) provided by the Japan Meteorological Agency. Further, the “cloud” in the present modification is aggregation of drops of water or ice crystals existing in the atmosphere, and while sizes of these are not particularly limited, the sizes are, for example, about 0.001 mm to 0.02 mm.

This can also improve accuracy related to the altitude distribution of the lightning strike risk degree.

Note that an execution position and processing content of the processing added in the description related to the second modification are not limited to the above-described content if the lightning strike risk degrees related to all the unit spaces located at positions lower than the cloud base are set at “low”.

The present embodiment incorporates the following technical ideas.

(1)

A lightning strike risk degree derivation device that derives a lightning strike risk degree for each of a plurality of regions divided by latitude and longitude into a mesh shape, the lightning strike risk degree derivation device comprising:
an echo intensity derivation unit that derives an altitude distribution of echo intensity in a predetermined altitude range for each of the plurality of regions using observation data acquired from meteorological radar;
an air temperature derivation unit that derives an altitude distribution of air temperature in the predetermined altitude range for each of the plurality of regions using observation data acquired from a meteorological observation device;
a feature amount derivation unit that derives a feature amount to be used to derive a lightning strike risk degree; and
a lightning strike risk degree derivation unit that derives the lightning strike risk degree using the feature amount, wherein
the feature amount derivation unit derives integrated echo intensity that is an integrated value of the echo intensity in at least part of the predetermined altitude range for each of the plurality of regions, and
the lightning strike risk degree derivation unit derives an altitude distribution of the lightning strike risk degree for each of the plurality of regions using the integrated echo intensity and the altitude distribution of the air temperature.
   (2)

The lightning strike risk degree derivation device according to the above-described (1), wherein
the feature amount derivation unit derives specific temperature zone integrated echo intensity that is an integrated value of the echo intensity corresponding to a first temperature range within the predetermined altitude range for each of the plurality of regions using the altitude distribution of the air temperature, and
the lightning strike risk degree derivation unit derives the altitude distribution of the lightning strike risk degree for each of the plurality of regions using at least the specific temperature zone integrated echo intensity.
   (3)

The lightning strike risk degree derivation device according to the above-described (1) or (2), wherein
the feature amount derivation unit derives vertical integrated echo intensity that is an integrated value of the echo intensity in the predetermined altitude range as a whole for each of the plurality of regions, and
the lightning strike risk degree derivation unit derives the altitude distribution of the lightning strike risk degree for each of the plurality of regions using at least the vertical integrated echo intensity.
   (4)

The lightning strike risk degree derivation device according to any one of the above-described (1) to (3), wherein
the lightning strike risk degree derivation unit derives a lightning strike risk degree not including altitude information for each of the plurality of regions using the feature amount derived by the feature amount derivation unit and derives the altitude distribution of the lightning strike risk degree for each of the plurality of regions using the derived lightning strike risk degree and the altitude distribution of the air temperature, and
the lightning strike risk degree derivation unit uses an algorithm derived using past lightning strike cases to derive the lightning strike risk degree not including the altitude information for each of the plurality of regions.
   (5)

The lightning strike risk degree derivation device according to the above-described (4), wherein the lightning strike risk degree derivation unit masks the derived lightning strike risk degree for each of the plurality of regions with a second temperature range to derive the altitude distribution of the lightning strike risk degree for each of the plurality of regions.

(6)

The lightning strike risk degree derivation device according to the above-described (5), wherein the second temperature range is determined in accordance with seasons.

(7)

The lightning strike risk degree derivation device according to any one of the above-described (1) to (6), wherein
a plurality of the meteorological observation devices exists in a range constituted by the plurality of regions,
the air temperature derivation unit derives an air temperature, an atmospheric pressure and an altitude corresponding to each of the plurality of regions from each of the meteorological observation devices, and
derives an altitude distribution of the air temperature for each of the plurality of regions using a hypsometric formula using air temperatures on a plurality of isobaric surfaces derived from a result of atmospheric analysis in addition to the derived air temperature, atmospheric pressure and altitude, and
an air temperature, a pressure and an altitude corresponding to an arbitrary region among the plurality of regions are determined by the meteorological observation device corresponding to the arbitrary region, and the meteorological observation device corresponding to the arbitrary region is determined by Voronoi tessellation using a point at which the meteorological observation device is provided.
   (8)

A lightning strike risk degree display system comprising:
the lightning strike risk degree derivation device according to any one of the above-described (1) to (7); and
an image display device,
wherein the image display device displays the altitude distribution of the lightning strike risk degree for each of the plurality of regions derived by the lightning strike risk degree derivation device in a three-dimensional manner.

This application claims priority of Japanese Patent Application No. 2022-106893 filed Jul. 1, 2022, the entire disclosure of which is incorporated by reference herein.

### REFERENCE SIGNS LIST

1 Lightning strike risk degree derivation device
10 Echo intensity derivation unit
20 Feature amount derivation unit
30 Air temperature derivation unit
40 Lightning strike risk degree derivation unit
50 Lightning strike risk degree display device
100 Lightning strike risk degree display system

1. A lightning strike risk degree derivation device that derives a lightning strike risk degree for each of a plurality of regions divided by latitude and longitude into a mesh shape, the lightning strike risk degree derivation device comprising:
an echo intensity derivation unit that derives an altitude distribution of echo intensity in a predetermined altitude range for each of the plurality of regions using observation data acquired from meteorological radar;
an air temperature derivation unit that derives an altitude distribution of air temperature in the predetermined altitude range for each of the plurality of regions using observation data acquired from a meteorological observation device;
a feature amount derivation unit that derives a feature amount to be used to derive a lightning strike risk degree; and
a lightning strike risk degree derivation unit that derives the lightning strike risk degree using the feature amount, wherein
the feature amount derivation unit derives integrated echo intensity that is an integrated value of the echo intensity in at least part of the predetermined altitude range for each of the plurality of regions, and
the lightning strike risk degree derivation unit derives an altitude distribution of the lightning strike risk degree for each of the plurality of regions using the integrated echo intensity and the altitude distribution of the air temperature.

2. The lightning strike risk degree derivation device according to claim 1, wherein
the feature amount derivation unit derives specific temperature zone integrated echo intensity that is an integrated value of the echo intensity corresponding to a first temperature range within the predetermined altitude range for each of the plurality of regions using the altitude distribution of the air temperature, and
the lightning strike risk degree derivation unit derives the altitude distribution of the lightning strike risk degree for each of the plurality of regions using at least the specific temperature zone integrated echo intensity.

3. The lightning strike risk degree derivation device according to claim 2, wherein
the feature amount derivation unit derives vertical integrated echo intensity that is an integrated value of the echo intensity in the predetermined altitude range as a whole for each of the plurality of regions, and
the lightning strike risk degree derivation unit derives the altitude distribution of the lightning strike risk degree for each of the plurality of regions using at least the vertical integrated echo intensity.

4. The lightning strike risk degree derivation device according to any one of claims 1, wherein
the lightning strike risk degree derivation unit derives a lightning strike risk degree not including altitude information for each of the plurality of regions using the feature amount derived by the feature amount derivation unit and derives the altitude distribution of the lightning strike risk degree for each of the plurality of regions using the derived lightning strike risk degree and the altitude distribution of the air temperature, and
the lightning strike risk degree derivation unit uses an algorithm derived using past lightning strike cases to derive the lightning strike risk degree not including the altitude information for each of the plurality of regions.

5. The lightning strike risk degree derivation device according to claim 4, wherein the lightning strike risk degree derivation unit masks the derived lightning strike risk degree for each of the plurality of regions with a second temperature range to derive the altitude distribution of the lightning strike risk degree for each of the plurality of regions.

6. The lightning strike risk degree derivation device according to claim 5, wherein the second temperature range is determined in accordance with seasons.

7. The lightning strike risk degree derivation device according to any one of claims 1, wherein
a plurality of the meteorological observation devices exists in a range constituted by the plurality of regions,
the air temperature derivation unit derives an air temperature, an atmospheric pressure and an altitude corresponding to each of the plurality of regions from each of the meteorological observation devices, and
derives the altitude distribution of the air temperature for each of the plurality of regions using a hypsometric formula using air temperatures on a plurality of isobaric surfaces derived from a result of atmospheric analysis in addition to the derived air temperature, atmospheric pressure and altitude, and
an air temperature, a pressure and an altitude corresponding to an arbitrary region among the plurality of regions are determined by the meteorological observation device corresponding to the arbitrary region, and the meteorological observation device corresponding to the arbitrary region is determined by Voronoi tessellation using a point at which the meteorological observation device is provided.

8. A lightning strike risk degree display system comprising:
the lightning strike risk degree derivation device according to any one of claims 1; and
an image display device,
wherein the image display device displays the altitude distribution of the lightning strike risk degree for each of the plurality of regions derived by the lightning strike risk degree derivation device in a three-dimensional manner.
